(19) United States
(12) Patent Application Publication
(10) Pub. No.: US 2026/0030480 A1
(43) Pub. Date: Jan. 29, 2026

(54) Effective Multi-Modal Retrieval-Augmented Generation (RAG) Agent With Twin-Database And Comprehensive Multi-Format Data Ingestion

(71) Applicant: Oracle International Corporation, Redwood Shores, CA (US)

(72) Inventors: Liyu Gong, Lexington, KY (US); Yuying Wang, Lexington, KY (US)

(73) Assignee: Oracle International Corporation, Redwood Shores, CA (US)

(21) Appl. No.: 19/001,309

(22) Filed: Dec. 24, 2024

Related U.S. Application Data
(60) Provisional application No. 63/676,820, filed on Jul. 29, 2024.

(51) Int. Cl. G06N 3/045; G06N 3/09

(52) U.S. Cl. CPC G06N 3/045; G06N 3/09

(57) ABSTRACT

Techniques for ingesting and using content items by a Retrieval-Augmented Generation (RAG) agent are disclosed. A RAG agent accesses content items that include textual data and/or non-textual image data (e.g., a table, a chart, a document, or a picture). When the RAG agent detects that content items include non-textual image data, the RAG agent invokes a large multimodal model (LMM) that is configured to classify the non-textual image data into a variety of classifications. The RAG agent also classifies the non-textual image data. Using this classification as selection criteria, the RAG agent selects an LMM that corresponds to the classification from a set of available LMMs. The RAG agent ensures that the selected LMM is configured to generate text from non-textual image data that corresponds to the classification. The generated text and extracted image data are both used by the RAG agent to respond to queries.

### BENEFIT CLAIMS: RELATED APPLICATIONS: INCORPORATION BY REFERENCE

This application claims the benefit of U.S. Provisional Patent Application 63/676,820, filed Jul. 29, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to machine learning systems. In particular, the present disclosure relates to Retrieval-Augmented Generation (RAG) agents.

### BACKGROUND

Retrieval-Augmented Generation (RAG) agents are used in applications requiring dynamic access to external information during the response generation process. Traditional machine learning models, particularly large language models (LLMs), rely on static training data and may lack the ability to provide responses based on information that becomes available after the training phase. In contrast, RAG agents address this limitation by retrieving up-to-date information from external sources, making them particularly useful in fields where information is constantly evolving or too vast to be incorporated into a model's static knowledge. This makes RAG agents well-suited for different applications, such as customer service chatbots, real-time data analysis, medical research, and personalized recommendation systems, where they retrieve and integrate relevant data on demand, offering more precise and contextually relevant outputs.

Retrieval-Augmented Generation (RAG) agents are commonly deployed in various sectors, such as healthcare, finance, and e-commerce due to their ability to process and synthesize information from large databases in real-time. In healthcare, for instance, RAG agents can quickly access vast repositories of medical literature and patient data to support medical diagnoses or provide personalized treatment recommendations. This contrasts with more basic machine learning models that are limited to the information they were trained on and unable to consider new research or patient-specific factors after the training period. In e-commerce, RAG agents enable personalized shopping experiences by analyzing current user behavior and historical data to suggest products, ensuring that recommendations remain relevant and timely. This retrieval-based approach significantly enhances the model's utility in domains where accuracy and up-to-date knowledge are crucial.

One of the distinctions between RAG agents and traditional machine learning models lies in their handling of data. Standard models operate within the confines of their training set and may struggle with novel queries that fall outside of their trained knowledge. In contrast, RAG agents are designed to overcome this limitation by retrieving data from external sources in real-time, making them highly adaptable to a wide range of queries. This retrieval mechanism allows RAG agents to augment their responses with fresh, domain-specific knowledge that would otherwise be unavailable to traditional models. As a result, RAG agents are capable of addressing a broader spectrum of questions with higher accuracy, particularly in domains where information evolves rapidly or is too extensive to be fully encapsulated within a training dataset.

Integrating agents into the RAG framework introduces enhanced flexibility and scalability compared to traditional machine learning models. While conventional models are often static and require retraining to incorporate new data, RAG agents operate in a more dynamic fashion, augmenting their knowledge base through external retrieval mechanisms. This allows RAG agents to remain relevant in real-time environments, where the need for current information is critical. Traditional models, by contrast, require frequent updates and retraining to maintain accuracy, a process that can be both time-consuming and computationally expensive. RAG agents provide a more efficient and scalable solution, for they leverage external data without needing to undergo constant retraining, making them ideal for applications requiring both precision and adaptability.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a machine learning engine in accordance with one or more embodiments;

FIG. 2 illustrates the operation of a machine learning engine in one or more embodiments;

FIG. 3 illustrates an ingestion system in accordance with one or more embodiments;

FIG. 4 illustrates an example set of operations for ingestion of content items for a RAG agent in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. MACHINE LEARNING ARCHITECTURE
3. GENERATIVE MODELS
4. RAG INGESTION ARCHITECTURE
5. CONTENT ITEM INGESTION FOR RAG AGENT
6. MULTI-MODAL RAG AGENT OPERATION
7. COMPUTER NETWORKS AND CLOUD NETWORKS
8. HARDWARE OVERVIEW
9. MISCELLANEOUS; EXTENSIONS

### 1. General Overview

Retrieval-Augmented Generation (RAG) agents refers to a class of artificial intelligence agents that combine retrieval techniques with generative models to produce contextually relevant responses. A RAG agent integrates a large multimodal model (LLM) with an intelligent retrieval system, allowing it to draw information from specific data sources and generate responses based on that information. This architecture enables the agent to provide answers that are both contextually accurate and grounded in factual data.

One or more embodiments execute a RAG agent that selects and uses an LLM to generate text from non-textual image data. Initially, a RAG agent accesses content items that include non-textual image data and/or textual data. The non-textual image data includes a table, a chart, a document, or a picture in an embodiment. Responsive to detecting content items with non-textual image data, the RAG agent invokes an LMM that is configured to classify non-textual image data into a variety of classifications. The RAG agent also detects that a content item includes non-textual image data corresponding to a particular classification. Using this classification as selection criteria, the RAG agent selects an LMM from a set of available LMMs, ensuring that the selected LMM is configured to generate text from non-textual image data that corresponds to the particular classification.

One or more embodiments described in this Specification and/or recited in the claims may not be included in this General Overview section.

### 2. Machine Learning Architecture

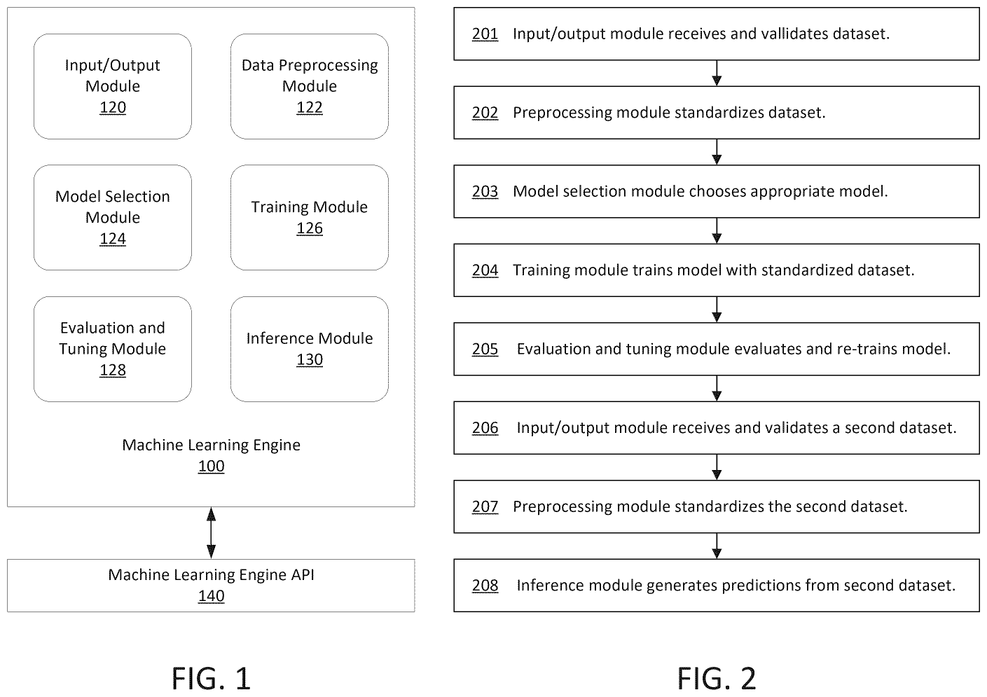

FIG. 1 illustrates a machine learning engine 100 in accordance with one or more embodiments. As illustrated in FIG. 1, machine learning engine 100 includes input/output module 120, data preprocessing module 122, model selection module 124, training module 126, evaluation and tuning module 128, and inference module 130.

In accordance with an embodiment, input/output module 120 serves as the primary interface for data entering and exiting the system, managing the flow and integrity of data. This module may accommodate a wide range of data sources and formats to facilitate integration and communication within the machine learning architecture.

In an embodiment, an input handler within input/output module 120 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 120 to be versatile in different operational contexts, whether processing historical datasets or streaming data.

In accordance with an embodiment, input/output module 120 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 120 includes an output framework designed to handle the distribution and exportation of outputs, predictions, or insights. Using the output framework, input/output module 120 formats these outputs into user-friendly and accessible formats, such as reports, visualizations, or data files compatible with other systems. Input/output module 120 also ensures secure and efficient transmission of these outputs to end-users or other systems in an embodiment and may employ encryption and secure data transfer protocols to maintain data confidentiality.

In accordance with an embodiment, data preprocessing module 122 transforms data into a format suitable for use by other modules in machine learning engine 100. For example, data preprocessing module 122 may transform raw data into a normalized or standardized format suitable for training ML models and for processing new data inputs for inference. In an embodiment, data preprocessing module 122 acts as a bridge between the raw data sources and the analytical capabilities of machine learning engine 100.

In an embodiment, data preprocessing module 122 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 122 may be configured to handle anomalies in different ways depending on context. Data preprocessing module 122 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 122 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 122 processes new data for inference, data preprocessing module 122 replicates the same preprocessing steps to ensure consistency with the training data format. This helps to avoid discrepancies between the training data format and the inference data format, thereby reducing the likelihood of inaccurate or invalid model predictions.

In an embodiment, model selection module 124 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 124 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 124 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 124 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 124 also considers computational efficiency and resource constraints. This is meant to help ensure the selected model is both accurate and practical in terms of computational and time requirements. In an embodiment, certain features of model selection module 124 are configurable such as a configured bias toward (or against) computational efficiency.

In accordance with an embodiment, training module 126 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 126 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 126 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 126 includes logic to handle different types of data and learning tasks. For instance, it includes different training routines for supervised learning (where the training data comes with labels) and unsupervised learning (without labeled data). In the case of deep learning models, training module 126 also manages the complexities of training neural networks that include initializing network weights, choosing activation functions, and setting up neural network layers.

In an embodiment, evaluation and tuning module 128 incorporates dynamic feedback mechanisms and facilitates continuous model evolution to help ensure the system's relevance and accuracy as the data landscape changes. Evaluation and tuning module 128 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 128 performs continuous model tuning by using hyperparameter optimization. Evaluation and tuning module 128 performs an exploration of the hyperparameter space using algorithms, such as grid search, random search, or more sophisticated methods like Bayesian optimization. Evaluation and tuning module 128 uses these algorithms to iteratively adjust and refine the model's hyperparameters-settings that govern the model's learning process but are not directly learned from the data-to enhance the model's performance. This tuning process helps to balance the model's complexity with its ability to generalize and attempts to avoid the pitfalls of underfitting or overfitting.

In an embodiment, evaluation and tuning module 128 integrates data feedback and updates the model. Evaluation and tuning module 128 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 128 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 128 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 130 transforms data raw data into actionable, precise, and contextually relevant predictions. In addition to processing and applying a trained model to new data, inference module 130 may also include post-processing logic that refines the raw outputs of the model into meaningful insights.

In an embodiment, inference module 130 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 130 transforms the outputs of a trained model into definitive classifications. Inference module 130 employs the underlying model as a tool to generate probabilistic outputs for each potential class. It then engages in an interpretative process to convert these probabilities into concrete class labels.

In an embodiment, when inference module 130 receives the probabilistic outputs from the model, it analyzes these probabilities to determine how they are distributed across some or every potential class. If the highest probability is not significantly greater than the others, inference module 130 may determine that there is ambiguity or interpret this as a lack of confidence displayed by the model.

In an embodiment, inference module 130 uses thresholding techniques for applications where making a definitive decision based on the highest probability might not suffice due to the critical nature of the decision. In such cases, inference module 130 assesses if the highest probability surpasses a certain confidence threshold that is predetermined based on the specific requirements of the application. If the probabilities do not meet this threshold, inference module 130 may flag the result as uncertain or defer the decision to a human expert. Inference module 130 dynamically adjusts the decision thresholds based on the sensitivity and specificity requirements of the application, subject to calibration for balancing the trade-offs between false positives and false negatives.

In accordance with an embodiment, inference module 130 contextualizes the probability distribution against the backdrop of the specific application. This involves a comparative analysis, especially in instances where multiple classes have similar probability scores, to deduce the most plausible classification. In an embodiment, inference module 130 may incorporate additional decision-making rules or contextual information to guide this analysis, ensuring that the classification aligns with the practical and contextual nuances of the application.

In regression models, where the outputs are continuous values, inference module 130 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 130 incorporates domain-specific adjustments into its post-processing routine. This involves tailoring the model's output to align with specific industry knowledge or contextual information. For example, in financial forecasting, inference module 130 may adjust predictions based on current market trends, economic indicators, or recent significant events, ensuring that the outputs are both statistically accurate and practically relevant.

In an embodiment, inference module 130 includes logic to handle uncertainty and ambiguity in the model's predictions. In cases where inference module 130 outputs a measure of uncertainty, such as in Bayesian inference models, inference module 130 interprets these uncertainty measures by converting probabilistic distributions or confidence intervals into a format that can be easily understood and acted upon. This provides users with both a prediction and an insight into the confidence level of that prediction. In an embodiment, inference module 130 includes mechanisms for involving human oversight or integrating the instance into a feedback loop for subsequent analysis and model refinement.

In an embodiment, inference module 130 formats the final predictions for end-user consumption. Predictions are converted into visualizations, user-friendly reports, or interactive interfaces. In some systems, like recommendation engines, inference module 130 also integrates feedback mechanisms, where user responses to the predictions are used to continually refine and improve the model, creating a dynamic, self-improving system.

FIG. 2 illustrates the operation of a machine learning engine in one or more embodiments. In an embodiment, input/output module 120 receives a dataset intended for training (Operation 201). This data can originate from diverse sources, like databases or real-time data streams, and in varied formats, such as CSV, JSON, or XML. Input/output module 120 assesses and validates the data, ensuring its integrity by checking for consistency, data ranges, and types.

In an embodiment, training data is passed to data preprocessing module 122. Here, the data undergoes a series of transformations to standardize and clean it, making it suitable for training ML models (Operation 202). This involves normalizing numerical data, encoding categorical variables, and handling missing values through techniques like imputation.

In an embodiment, prepared data from the data preprocessing module 122 is then fed into model selection module 124 (Operation 203). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 126 trains the selected model with the prepared dataset (Operation 204). It implements learning algorithms to adjust the model's internal parameters, optimizing them to identify patterns and relationships in the training data. Training module 126 also addresses the challenge of overfitting by implementing techniques, like regularization and early stopping, ensuring the model's generalizability.

In an embodiment, evaluation and tuning module 128 evaluates the trained model's performance using the validation dataset (Operation 205). Evaluation and tuning module 128 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 120 receives a dataset intended for inference. Input/output module 120 assesses and validates the data (Operation 206).

In an embodiment, data preprocessing module 122 receives the validated dataset intended for inference (Operation 207). Data preprocessing module 122 ensures that the data format used in training is replicated for the new inference data, maintaining consistency and accuracy for the model's predictions.

In an embodiment, inference module 130 processes the new data set intended for inference, using the trained and tuned model (Operation 208). It applies the model to this data, generating raw probabilistic outputs for predictions. Inference module 130 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 140 allows for applications to leverage machine learning engine 100. In an embodiment, machine learning engine API 140 may be built on a RESTful architecture and offer stateless interactions over standard HTTP/HTTPS protocols. Machine learning engine API 140 may feature a variety of endpoints, each tailored to a specific function within machine learning engine 100. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 140 is equipped to support SOAP-based interactions. This extension involves defining a WSDL (Web Services Description Language) document that outlines the API's operations and the structure of request and response messages. In an embodiment, machine learning engine API 140 supports various data formats and communication styles. In an embodiment, machine learning engine API 140 endpoints may handle requests in JSON format or any other suitable format. For example, machine learning engine API 140 may process XML, and it may also be engineered to handle more compact and efficient data formats, such as Protocol Buffers or Avro, for use in bandwidth-limited scenarios.

In an embodiment, machine learning engine API 140 is designed to integrate WebSocket technology for applications necessitating real-time data processing and immediate feedback. This integration enables a continuous, bi-directional communication channel for a dynamic and interactive data exchange between the application and machine learning engine 100.

### 3. Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 120, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 122 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 124, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 126, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 128 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 130, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

The self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 4. Rag Ingestion Architecture

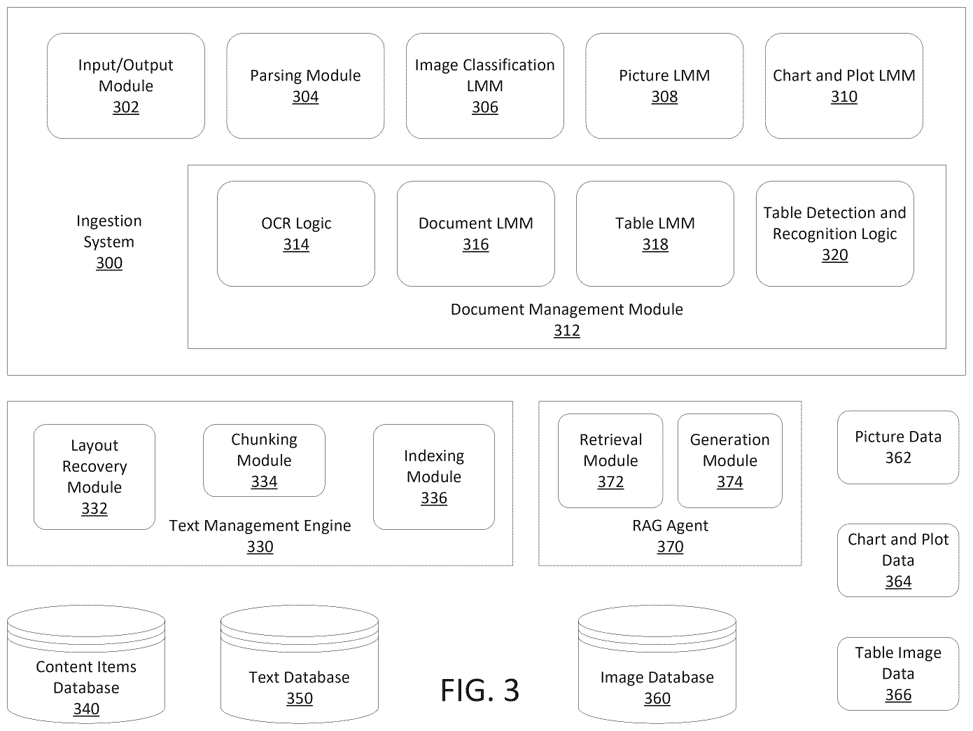

FIG. 3 illustrates an ingestion system 300 in accordance with one or more embodiments. As illustrated in FIG. 3, system 300 includes input/output module 302, parsing module 304, image classification LMM 306, picture LMM 308, chart and plot LMM 310, and document management module 312. In an embodiment, document management module 312 includes OCR logic 314, document LMM 316, table LMM 318, and table detection and recognition logic 320. FIG. 3 also illustrates a text management engine 330 in accordance with one or more embodiments. As illustrated in FIG. 3, text management engine 330 includes layout recovery module 332, chunking module 334, and indexing module 336. Additionally, FIG. 3 illustrates content items database 340, text database 350, and image database 360. Image database 360 may include picture data 362, chart and plot data 364, and table image data 366 in one or more embodiments. A RAG agent 370 is also illustrated in FIG. 3. The RAG agent 370 includes a retrieval module 372 and a generation module 374. In one or more embodiments, the system or other components shown in FIG. 3 may include more or fewer components than the components illustrated in FIG. 3. The components illustrated in FIG. 3 may be local to or remote from each other. The components illustrated in FIG. 3 may be implemented in software and/or hardware. Components may be distributed over multiple applications and/or machines. Multiple components may be combined into one application and/or machine. Operations described with respect to one component may instead be performed by another component.

In accordance with one or more embodiments, ingestion system 300 is configured to ingest content items for use with a RAG system. Content items, such as content items database 340, are not inherently compatible with RAG systems. For example, content items may include documents, videos, or other data files that have various types of data in addition to textual data. For example, content items may include encoded text, images of text, images having no text, tables, charts, and other information. Although raw textual data may be easily ingested for use with a RAG system, the ingestion of other types of information and storing the information in a compatible format may be more difficult to accomplish. System 300 is configured to detect and ingest content items having a variety of characteristics and various types of embedded information.

In accordance with one or more embodiments, input/output module 302 serves as the primary interface for data entering and exiting the system, managing the flow and integrity of data. This module may accommodate a wide range of data sources and formats to facilitate integration and communication within the system architecture.

In an embodiment, an input handler within input/output module 302 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 302 to be versatile in different operational contexts, whether processing historical datasets or streaming data.

In accordance with an embodiment, input/output module 302 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 302 includes an output framework designed to handle the distribution and exportation of outputs, predictions, or insights. Using the output framework, input/output module 302 formats these outputs into user-friendly and accessible formats, such as reports, visualizations, or data files compatible with other systems. Input/output module 302 also ensures secure and efficient transmission of these outputs to end-users or other systems in an embodiment and may employ encryption and secure data transfer protocols to maintain data confidentiality.

In accordance with one or more embodiments, parsing module 304 is configured to parse content items that comprise both textual data and non-textual image data, separating these distinct components based on their format and structure. If the content is embedded in documents, multimedia files, or presentation materials, parsing module 304 efficiently processes the various types of data and ensures they are categorized and separated correctly. For example, the types of non-textual image data may include any of the following: charts and graphs, such as bar charts, line graphs, pie charts, scatter plots, histograms, area charts, bubble charts, radar charts, and Gantt charts; pictures, such as photographs, illustrations, diagrams, clip art, and infographics; and videos that can be embedded or linked, along with animated GIFs.

Additionally, embedded presentations from platforms, like PowerPoint, Prezi, and Keynote, can be included as well as audio elements, such as embedded audio clips, linked audio files, voice recordings, and music files. Interactive elements might feature interactive charts created with tools like D3.js, form controls like checkboxes and radio buttons, and hyperlinks. Data tables, embedded spreadsheets, and various flowcharts and diagrams, such as organizational charts, network diagrams, mind maps, and process flow diagrams can also be integrated. Geographic maps, heat maps, and topographic maps provide spatial data visualization, while embedded applications and widgets, including interactive widgets, web embeds like Google Maps, and interactive simulations, enhance user interaction. Documents can also comprise 3D models, like CAD drawings, 3D renderings, and VR/AR models. Forms, surveys with embedded results, annotations (including highlighted text, comments, notes, and drawing annotations), screen captures, recordings, custom icons, standard symbols, digital signatures, rubber stamps, and QR or barcodes enhance document functionality and clarity. This is not a comprehensive list, but it is illustrative of the need for a multi-modal RAG agent and the flexibility of various embodiments.

In accordance with one or more embodiments, in documents like PDFs, parsing module 304 identifies and separates textual data from non-textual image data by scanning the internal structure of the document. When an image is embedded, parsing module 304 recognizes the image's bounding box, isolates it as a distinct component, and simultaneously detects surrounding text through character encoding analysis. This ensures that both text and images are handled separately while maintaining their relative positions on the page for downstream processes. For vector-based images in PDFs, parsing module 304 analyzes graphic elements, such as paths and shapes, distinguishing them from raster images and text data.

In accordance with one or more embodiments, in a variety of document types, including HTML files, parsing module 304 identifies both textual elements and embedded images by examining object tags, metadata, or document markup. Text elements are processed separately from images, with components maintained independently for further processing. For example, in HTML content, images are recognized through <img> tags or CSS-based properties, while text and hyperlinks are handled as separate entities.

In accordance with one or more embodiments, when processing presentation files, parsing module 304 scans the slides to separate textual data from non-textual elements, including images, charts, and diagrams. Text within content placeholders or text boxes is identified and isolated from embedded images, which are recognized through their graphical properties and metadata. Parsing module 304 ensures that both textual data and non-textual image data are treated independently, preserving the layout and structure of the slides.

In videos, parsing module 304 separates non-textual image data, such as still frames or embedded graphics, from any text that might be present, including subtitle tracks. Text from subtitle streams is treated as separate data, distinct from the visual content of the video frames. Similarly, in audio files, parsing module 304 independently handles non-textual elements, like embedded cover art and associated text-based metadata (such as song titles and artist names), ensuring clear separation of these components.

Parsing module 304 applies a variety of approaches across many types of content items, whether they comprise textual data, non-textual image data, or both. By recognizing and categorizing these distinct elements, parsing module 304 maintains the integrity of data types while ensuring precise separation for further analysis, processing, or storage. This capability makes it versatile in handling a wide range of complex content types.

In accordance with one or more embodiments, parsing module 304 is configured to generate image identifiers for non-textual image data, such as pictures, charts/plots, and tables. Images are stored in image database 360, where the images are stored with an association to a corresponding image identifier. The image may also be associated with a corresponding content item identifier.

In accordance with one or more embodiments, parsing module 304 is configured to determine if an image is before, after, or between textual data. For example, a paragraph A occur before a particular image in a content item such as a PDF document. Paragraph B may occur after the particular image, so the order of the parsed items would be paragraph A, image, paragraph B. The image may be stored in an image database and associated with an image identifier (e.g., image_142435213). To ensure that the placement context is not lost during the parsing phase, parsing module 304 stores the image identifier and image description/summary as additional text in the text portion of the content item. In this case, for example, the text may be stored as <contents of paragraph A> <Image_142435213: <image description/summary>><contents of paragraph B>. However, this particular format is not required. Instead, the image identifier may be placed contextually near the image description/summary using other structures, so long as the context is preserved. In an embodiment, the textual data including the reference to the image identifier is stored in text database 350. The textual data is also stored with the corresponding content item identifier. Image identifiers may be used in this way for any type of non-textual image information, including pictures, charts/plots, and tables.

In accordance with one or more embodiments, image classification LMM 306 is configured to process images of a wide variety of image types and categorize the images into distinct classifications. Image classification LMM 306 accepts inputs, such as picture data, chart and plot data, table data, and other non-textual image data. When provided with an image, image classification LMM 306 first extracts relevant features through a pre-trained convolutional neural network (CNN) that analyzes various aspects, such as shapes, textures, and patterns, in the image. The extracted features are then passed through connected layers designed to map the visual data to predefined categories.

In accordance with an embodiment, for picture data, image classification LMM 306 processes the visual content to identify objects, scenes, or specific patterns using learned representations, followed by a classification step where the image is assigned to the most relevant category. When the input includes chart and plot data, image classification LMM 306 uses specialized layers to recognize axis labels, grid lines, and plotted data points, distinguishing between different chart types, such as bar graphs, scatter plots, or line charts. In the case of table data, image classification LMM 306 focuses on detecting grid structures, cell contents, and numeric or textual patterns within the table, classifying the data into appropriate table-related categories.

In accordance with an embodiment, throughout the process, image classification LMM 306 utilizes a series of loss functions during training to fine-tune classification accuracy. Backpropagation mechanisms may be used adjust weights to minimize classification errors. In an embodiment, image classification LMM 306 provides classification outputs that indicate the detected type of image, ensuring that the image is accurately categorized into a classification group based on its features.

In accordance with one or more embodiments, image classification LMM 306 leverages large-scale training on diverse multimodal data, allowing both the analysis of the visual content of images and the consideration of contextual information when relevant. This gives image classification LMM 306 an advantage over more traditional computer vision models, focusing primarily on low-level pixel information or fixed feature extraction methods. However, computer vision models may be used instead of classification LMM 306 in an embodiment. By integrating text-based data with visual data during training, image classification LMM 306 recognizes more complex relationships in an image. For example, when classifying charts or tables, image classification LMM 306 can identify the visual structure and also infer the nature of the data presented, such as the type of trend in a graph or the significance of values in a table. This multimodal learning enables more nuanced and flexible classification, accommodating a wider range of visual data inputs compared to models focused solely on image recognition.

In accordance with one or more embodiments, image classification LMM 306 can handle multiple image types within a single framework. Image classification LMM 306 can seamlessly switch between different data types, like pictures, charts, and tables, without needing separate pipelines. The LLM architecture allows image classification LMM 306 to generalize better across different tasks, given the extensive pre-training on diverse datasets that include text, images, and other data formats. This flexibility is particularly beneficial for handling complex, mixed datasets where multiple image types may appear in sequence or combination, enabling image classification LMM 306 to output reliable results across a broad range of use cases. Additionally, scalability in terms of model size and the amount of data processed contributes to higher classification accuracy and robustness in dealing with various image complexities.

In accordance with one or more embodiments, LMMs may be used to extract, derive, or infer text from the non-textual image data. These may be referred to as machine-generated image descriptions, generated text, or generated textual data. For example, picture LMM 308, chart and plot LMM 310, document LMM 316, table LMM 318, and other LMMs that may be employed to analyze content items may generate image descriptions or textual data from content items that include non-textual image data.

In accordance with one or more embodiments, picture LMM 308 is configured to generate text based on identified visual and textual information through a combination of image classification, feature extraction, and language modeling. After the visual elements in the image are identified and classified, picture LMM 308 maps these classifications to corresponding language tokens or descriptions that were learned during training. The training phase involves large datasets where images are paired with descriptive text. By analyzing these pairs, picture LMM 308 learns the relationships between visual patterns and the specific language typically used to describe them.

In accordance with one or more embodiments, when picture LMM 308 identifies an object like a “mountain,” it refers to internal language representations associated with that class, selecting appropriate words or phrases to describe the mountain within the context of the scene. For example, if it also identifies “snow” and “sky,” the language model combines these concepts using grammar rules and contextual knowledge learned from the training data to produce a coherent sentence such as “snow-capped mountains under a clear blue sky.” The selection of words and the structure of the sentence are guided by the model's ability to generate natural language, learned through exposure to vast amounts of text data during training.

In accordance with one or more embodiments, in the case of a technical diagram, after the visual components like “server,” “data flow,” and “cloud storage” are recognized, picture LMM 308 generates text by linking these components to predefined technical language patterns. For instance, if an arrow labeled “data flow” connects a server to cloud storage, picture LMM 308 interprets this as a relationship and generates a sentence like, “Data flows from the server to cloud storage.” Picture LMM 308 is prepared to describe this relationship because picture LMM 308 has seen similar diagrams and corresponding descriptions during its training phase. Picture LMM 308 builds these relationships using learned associations between visual symbols, technical terms, and sentence structures commonly used in technical documentation.

In accordance with one or more embodiments, logic that extracts embedded text helps refine the output by directly incorporating recognized words or phrases into the generated description. For example, if the diagram includes labels like ““Tenant” or “Load Balancer,” picture LMM 308 incorporates these specific terms into the output text, ensuring that the generated description aligns with the detailed technical content of the image. This process of text generation is dynamic and context-dependent, allowing picture LMM 308 to produce relevant and accurate descriptions based on the classified information and its learned language models.

In accordance with one or more embodiments, chart and plot LMM 310 is configured to process and generate text based on charts and plots, such as bar graphs, line charts, or scatter plots. When a chart or plot is input, chart and plot LMM 310 first processes the visual data through a series of convolutional layers, similar to how other models handle images, but optimized to identify structured elements like axes, data points, bars, lines, and labels. These layers detect and extract features specific to chart visualization, such as the placement and orientation of axes, the scale of the plot, the position and shape of data markers, and any accompanying legends or labels.

In accordance with one or more embodiments, after extracting these features, classification logic identifies the components of the chart. For example, classification logic classifies the x-axis and y-axis, recognizes gridlines, and identifies data points or bars based on their shape and position. If the chart comprises embedded text, such as axis labels, chart titles, or legend descriptions, optical character recognition (OCR) logic extracts this text for further processing.

In accordance with one or more embodiments, chart and plot LMM 310 uses the recognized elements to generate a textual summary of the chart's contents. For example, if classification logic identifies a bar chart with labeled axes and varying bar heights, chart and plot LMM 310 classifies the data categories (based on x-axis labels) and the corresponding values (based on y-axis positions or numerical labels). Chart and plot LMM 310 then generates text that reflects the relationships between the data points, such as, “This bar chart shows sales figures for four regions, with Region A having the highest sales at $1,000,000, while Region D has the lowest at $300,000.”

In accordance with one or more embodiments, in the case of a line chart, chart and plot LMM 310 detects the trend by analyzing the sequence and direction of data points connected by lines. Chart and plot LMM 310 classifies the data trends, such as upward or downward movements, and correlates these trends with the time or categorical data on the x-axis. Based on the identified pattern, chart and plot LMM 310 generates text that summarizes the overall trend, such as, “The line chart shows a steady increase in temperature from January to June, peaking at 30° C. in June.”

In accordance with one or more embodiments, chart and plot LMM 310's ability to interpret data from a chart is reliant on its training with large datasets of charts paired with textual descriptions. During training, chart and plot LMM 310 learns to associate the visual characteristics of different chart types with corresponding language patterns. For example, chart and plot LMM 310 learns that a steep slope in a line chart often indicates rapid change, and taller bars in a bar chart represent higher values. Chart and plot LMM 310 also learns how to describe these relationships using natural language, ensuring that the generated text accurately reflects the visual data.

In accordance with one or more embodiments, for plots, such as scatter plots, chart and plot LMM 310 identifies the individual data points and their distribution across the chart. Chart and plot LMM 310 recognizes patterns, like clustering, outliers, or linear correlations. If a scatter plot shows a positive correlation between two variables, chart and plot LMM 310 generates text like, “This scatter plot indicates a positive correlation between variable X and variable Y, where higher values of X are associated with higher values of Y.”

In accordance with one or more embodiments, in addition to generating descriptions of data relationships, chart and plot LMM 310 integrates recognized text, such as axis titles or labels, into the output. The OCR module helps identify specific terms or numerical values in the chart, such as “Revenue” on the y-axis or “$5,000” as a data label that chart and plot LMM 310 incorporates into the generated description. For instance, in a plot showing revenue over time, chart and plot LMM 310 might generate, “Revenue increased steadily from January to June, reaching $5,000 in June.”

In accordance with one or more embodiments, chart and plot LMM 310 uses its learned associations between visual data structures, numerical relationships, and language to produce detailed and accurate descriptions that capture the essential content and trends of the input chart or plot. Chart and plot LMM 310's specialized architecture is tailored to recognize the distinct visual features of charts and plots and map those to language that appropriately reflects the underlying data.

In accordance with one or more embodiments, chart and plot LMM 310 will extract the captions as belows (i.e., bounding boxes). In the context of text capture from images, a “bounding box,” or “bbox,” is a rectangular border that fully encloses a region of interest, such as text, within an image. The bbox is typically defined by the coordinates of its corners, usually the top-left and bottom-right corners. This bbox is used to identify and isolate specific parts of the image for further processing such as optical character recognition (OCR) to extract text. The bboxes of the chart/plots are enlarged, and the surrounding text overlapped with the enlarged bboxes will be analyzed to detect the captions. These captions may be combined together with the descriptions for the image and indexed in the text database.

In accordance with one or more embodiments, document management module 312 is configured to extract and generate text from documents that are classified as images. In an embodiment, document management module 312 includes one or more of the following: OCR logic 314, document LMM 316, table LMM 318, and table detection and recognition logic 320.

In accordance with one or more embodiments, OCR logic 314 is configured to process images comprising text, extract that text, and generate machine-readable output. When an image is input, OCR logic 314 begins by preprocessing the image to enhance the clarity of the text elements. This preprocessing may involve several steps, such as binarization (converting the image to black and white), noise reduction, and contrast adjustment, to make the text more discernible from the background. These steps are critical for improving the accuracy of text extraction, especially in images where the text may be distorted, blurry, or overlapping with other visual elements.

In accordance with one or more embodiments, once the image has been preprocessed, OCR logic 314 uses a convolutional neural network (CNN) to detect and isolate regions of the image that contain text. This text detection process involves scanning the image for shapes and patterns that correspond to letter-like structures, such as horizontal or vertical lines and curves. The model identifies blocks of text by segmenting the detected regions that may be paragraphs, individual lines, or even single characters, depending on the complexity of the input.

In accordance with one or more embodiments, after identifying the text regions, OCR logic 314 applies a character recognition step. This involves recognizing characters in the detected regions by comparing the visual features of each letter or number with its learned representations. The model is trained on a large dataset of labeled text images, allowing it to learn the shapes and variations of letters and digits across different fonts, sizes, and styles. For handwritten text or stylized fonts, OCR logic 314 uses specialized pattern recognition techniques to account for variability in letter shapes. Each character is classified and matched to its corresponding Unicode or ASCII representation.

In accordance with one or more embodiments, OCR logic 314 then reconstructs the extracted characters into coherent text strings. This involves aligning the recognized characters based on their spatial relationships and formatting, such as left-to-right or top-to-bottom reading order, which is important for handling multi-line text or languages that have different writing directions. If the detected text includes numbers, symbols, or non-alphabetic characters, OCR logic 314 also identifies and processes those.

In accordance with one or more embodiments, in cases where the image comprises distorted, skewed, or curved text, OCR logic 314 applies geometric transformations to normalize the text regions before character recognition. Techniques like perspective correction or text de-warping adjust the orientation of the text, making it easier to recognize. For example, if the input image comprises a photo of a street sign viewed from an angle, OCR logic 314 corrects the skew, so the text appears straight, improving the recognition accuracy.

In accordance with one or more embodiments, once the text is extracted and reconstructed, OCR logic 314 uses contextual understanding to improve the accuracy of the output. The model can apply language-based corrections by referencing common word dictionaries or language models. For instance, if OCR logic 314 recognizes a word but the initial output comprises an uncommon or misspelled sequence of characters, the model may correct it to a more probable word based on language patterns. This step is particularly useful in reducing recognition errors caused by irregular fonts or low-quality input images.

In accordance with one or more embodiments, the final output of OCR logic 314 is a machine-readable text file or structured data format, where the extracted text is presented in an organized form. The output can then be further processed for different tasks, such as text indexing, searching, or data entry automation. OCR logic 314 is highly adaptable to various use cases, including document digitization, automatic data extraction from forms, or real-time text recognition in photos and video streams.

In accordance with one or more embodiments, document LMM 316 is configured to extract text from images of documents by leveraging a more complex understanding of both visual and textual patterns. When an image of a document is input, Document LMM 316 begins by processing the visual data through a series of convolutional layers, optimized to detect both structural and textual elements within the document. These layers identify regions of interest, such as paragraphs, headings, tables, and other formatted text areas, by recognizing shapes and patterns that correspond to lines of text, white spaces, and document layout features.

In accordance with one or more embodiments, after detecting these regions, document LMM 316 applies segmentation techniques to break the document down into its component sections, such as blocks of text, individual lines, or words. The model's segmentation step is guided by its understanding of typical document structures, ensuring that text is correctly separated from other elements, like images, graphics, or tables. Segments are then processed further to identify the specific text it contains.

In accordance with one or more embodiments, for character recognition, document LMM 316 uses a learned representation of letters, numbers, and symbols, recognizing them based on visual patterns stored in its internal models. Document LMM 316 classifies the characters by matching the shapes in the image to its learned character sets that are derived from a wide range of fonts, handwriting styles, and character formats. Document LMM 316 is also trained to account for various document layouts, including multi-column formats, footnotes, or embedded charts, adjusting its recognition approach based on the overall structure of the document.

In accordance with one or more embodiments, once the characters and words are recognized, document LMM 316 reconstructs them into coherent text by considering the spatial arrangement of words and lines within the document. The model uses its understanding of document formatting and layout conventions to ensure that multi-line text is read in the correct order, and text from different columns or sections is handled appropriately.

In accordance with one or more embodiments, in addition to recognizing individual characters, document LMM 316 applies a language model that helps interpret and correct the recognized text. This language model cross-references common words, phrases, and grammatical structures, improving accuracy by fixing potential misclassifications. For instance, if a word is partially misrecognized due to noise or a low-quality image, the model may adjust the output based on context and likely word choices.

In accordance with one or more embodiments, if the document includes specialized elements, like tables or diagrams with embedded text, document LMM 316 handles these by identifying the layout and structure first, extracting the text based on the format and position within the table or chart. The extracted text is then integrated into the broader document output in a logical and coherent way, preserving the overall structure of the document.

In accordance with one or more embodiments, document LMM 316's final output is a structured text representation of the document, where the text is extracted in the correct reading order with formatting and layout considerations taken into account. This extracted text can be further used for tasks, like document archiving, automated analysis, or digital processing, while maintaining the integrity and structure of the original document.

In accordance with one or more embodiments, table detection and recognition logic 320 is configured to extract text from tables and generate structured text output that preserves the original table format. Upon receiving an image of a table, table detection and recognition logic 320 applies a series of convolutional layers to identify structural components, such as lines, grid patterns, and cell boundaries. These layers detect the spatial layout of the table by recognizing horizontal and vertical lines that indicate rows and columns. In the absence of visible lines, table detection and recognition logic 320 relies on the alignment of text and spacing to infer the table structure.

In accordance with one or more embodiments, after identifying the table's structure, table detection and recognition logic 320 performs cell segmentation. This involves dividing the table into individual cells based on the grid-like patterns detected during the initial phase. The segmented cells are then processed individually for text extraction. Table detection and recognition logic 320 applies character recognition techniques within the cells to identify the text, which may include numerical data, alphabetical text, or other characters. Text is extracted based on its visual representation and then classified according to the recognized characters and their arrangement within the cell.

In accordance with one or more embodiments, table detection and recognition logic 320 preserves the structure of the table by encoding the relationship between rows, columns, and cells. Table detection and recognition logic 320 generates a structured output, such as HTML or another markup language, using appropriate tags and attributes to define the table layout. For instance, table detection and recognition logic 320 generates <table>, <tr>, and <td> tags for rows and cells, maintaining the table's format. Table detection and recognition logic 320 also handles special cases, such as merged cells, where attributes like colspan or rowspan are used to represent the spanning of multiple columns or rows. The generated output maintains the structure of the original table, ensuring that the relationships between data points are preserved.

In accordance with one or more embodiments, for tables with complex structures, such as nested tables or multi-layered headers, table detection and recognition logic 320 identifies and processes these elements separately. Table detection and recognition logic 320 extracts the nested structures and encodes them using hierarchical tags to represent their arrangement. Table detection and recognition logic 320 adapts to different table formats by recognizing patterns in layout and adjusting segmentation and output generation accordingly.

In accordance with one or more embodiments, table detection and recognition logic 320 outputs the table in a structured format that can be rendered digitally. Table detection and recognition logic 320 ensures that the table's layout, cell boundaries, and text are accurately represented in the output format, allowing for consistent digital representation of the table's content.

In accordance with one or more embodiments, table LMM 318 is configured to extract text from tables and generate structured output using an LMM approach. When an image containing a table is input, table LMM 318 first processes the visual data through a series of layers optimized for both visual and textual pattern recognition. These layers identify key structural elements of the table, such as borders, gridlines, and cell boundaries, by detecting visual features like horizontal and vertical alignments as well as any discernible patterns that suggest a table layout.

In accordance with one or more embodiments, after the structural elements are detected, table LMM 318 applies segmentation techniques to separate the table into individual cells. The cells are processed individually, where the LMM component of table LMM 318 performs both character recognition and contextual interpretation of the text within the cells. The model extracts text by recognizing patterns that represent characters, words, and numbers, using its multimodal understanding to accurately identify elements within the visual context of the cell.

In accordance with one or more embodiments, table LMM 318 leverages its ability to understand the spatial relationships between table components to preserve the structure of the table. As the text is extracted, table LMM 318 encodes the relationships between rows, columns, and cells, representing the table in structured formats like HTML. The model generates appropriate tags such as <table>, <tr>, and <td>, while handling more complex cases like merged cells with attributes such as colspan and rowspan. Table LMM 318 ensures that the visual layout of the table is accurately reflected in the output format, preserving the organization and relationships between data points.

In accordance with one or more embodiments, for tables with more complex structures, such as those with nested tables or multi-tiered headers, table LMM 318 uses its learned understanding of document layouts to adjust its segmentation and recognition processes. Table LMM 318 identifies hierarchical structures within the table and encodes these nested components in the appropriate format. Additionally, the LMM leverages contextual knowledge from training on a wide variety of table formats and structures, allowing it to adapt to different table designs and accurately represent their layouts in the generated output.

In accordance with one or more embodiments, table LMM 318 also generates structured output with detailed formatting, ensuring that the table's structure, including the text, is accurately represented in the chosen format. This allows for consistent rendering and digital representation of tables across various platforms. By combining its visual recognition capabilities with its multimodal language understanding, table LMM 318 is able to handle both the text extraction and the generation of a structured table format in a way that reflects the original layout.

In accordance with one or more embodiments, text management engine 330 is configured to handle the output of ingestion system 300 and prepare it for storage in text database 350. In an embodiment, text management engine 330 includes one or more of the following: layout recovery module 332, chunking module 334, and indexing module 336.

In accordance with one or more embodiments, layout recovery module 332 is configured to combine textual data extracted from content items with text that is generated from non-textual image data. When parsing module 304 separates textual data from non-textual image data, parsing module 304 or other logic associated with ingestion system 300 generates an image identifier associated with the non-textual image data. The image identifier is used for a variety of functions. For example, the image identifier may be used to reference the non-textual image data when it is stored in a database such as image database 360. It may also be used as a placeholder for the image that represents the non-textual image data in the textual data. During the text extraction and generation step associated with the non-textual image data, the image identifier may be tracked to ensure that the text extracted or generated from the non-textual image data is associated with the image identifier.

In accordance with one or more embodiments, layout recovery module 332 is configured to match image identifiers stored in textual data with image identifiers associated with the text that is generated or extracted from the non-textual image data. Layout recovery module 332 is configured to insert text extracted from images into the place within the textual data where the image was found in the original content item. For example, textual data extracted from a content item may include a first string of text, followed by an image identifier or reference to an image identifier, followed by a second string of text. The image identifier references both an image (non-textual image data) and text extracted from the image. In an embodiment, layout recovery module 332 places the text extracted from the image associated with the image identifier into the textual data. The extracted text may be placed between the first string of text and the second string of text or may be placed elsewhere in the textual data with a reference that indicates that the text is associated with the image identifier. In an embodiment, the extracted text replaces the image identifier. In another embodiment, the image identifier remains in the textual data, allowing retrieval of the stored image by the RAG agent if necessary or desirable.

In accordance with one or more embodiments, chunking module 334 is configured to break large bodies of text into manageable chunks based on relevance. When a large text input is processed, chunking module 334 first analyzes the content to identify logical divisions using a combination of linguistic patterns and contextual analysis. The module scans the text for indicators of topic boundaries, such as paragraph breaks, sentence structure, and thematic shifts, allowing it to detect sections where the text can be split meaningfully.

In accordance with one or more embodiments, chunking module 334 applies segmentation logic to divide the text into smaller, coherent pieces. These chunks are created by grouping together sentences or paragraphs that share common themes or topics. The module ensures that chunks comprise self-contained information by evaluating the relevance of each part to the larger context. This process is achieved through a relevance model that considers key terms, topic continuity, and how sentences contribute to the overall flow of the document.

In an embodiment, chunking module 334 may chunk textual data based at least in part on the textual data's adjacency to non-textual image data. For example, if textual data is found within a pre-configured threshold distance from non-textual image data, the textual data and the text that is extracted from the non-textual image data may be chunked together. The processing and chunking of the textual data and non-textual image data may be based on a dynamic threshold that is determined based on the type of data location of data, tags found within the data, or other attributes associated with the data.

In accordance with one or more embodiments, the size of the chunks is determined by predefined parameters that can be adjusted based on the requirements of the task, such as storage limits or readability needs. Chunking module 334 maintains a balance between chunk size and coherence, ensuring that chunks are neither too small, which might lose context, nor too large, which could overwhelm processing systems. The module may also reanalyze chunks after initial segmentation to ensure that chunks are contextually appropriate and comprises relevant content without being overly broad or redundant.

Chunking module 334 is capable of handling various text structures, including documents with headings, lists, and nested topics. The module identifies and preserves these structures during the chunking process, ensuring that the output retains logical relationships between sections of text. In applications like summarization, retrieval, or further processing, the resulting chunks provide a manageable and relevant subset of the original text for downstream tasks. In an embodiment, chunking module ensures that text extracted from non-textual image data remains in the same chunk. In another embodiment, text extracted from non-textual image data may be separated for chunking purposes to satisfy chunk size constraints.

In accordance with one or more embodiments, indexing module 336 is configured to index the chunks generated by chunking module 334 and associate them with the content items from which the text was extracted. Once chunking module 334 processes the text and creates manageable chunks based on relevance, indexing module 336 takes each chunk and assigns it a unique identifier. This identifier allows the chunk to be easily referenced and retrieved later.

In accordance with one or more embodiments, indexing module 336 catalogs the chunks by creating an index that maps the chunks back to its original content source, whether it be a document, database entry, or other text-based resource. This mapping includes metadata about the source content, such as the title, document ID, location within the text, and any other relevant attributes. The indexing process also captures key terms or concepts present in each chunk, enabling efficient search and retrieval based on content. The index and the chunked text is stored in text database 350 in accordance with an embodiment.

In accordance with one or more embodiments, the index generated by indexing module 336 is structured to allow for fast access to specific chunks based on queries or relevance. The module organizes the indexed chunks in a way that preserves the logical relationship between them and their source content. This enables downstream applications, such as search engines or content management systems, to efficiently retrieve the exact chunks of text associated with specific topics, keywords, or sections of the original document.

In accordance with one or more embodiments, indexing module 336 continuously updates the index as new chunks are created or modified, ensuring that the index remains synchronized with the content. This capability allows the system to maintain an accurate association between extracted chunks and their corresponding content items even as documents or text sources evolve over time.

In accordance with one or more embodiments, content items database 340 represents any type of storage unit and/or device (e.g., a file system, database, collection of tables, or any other storage mechanism) for storing data. Furthermore, content items database 340 may include multiple different storage units and/or devices. The multiple different storage units and/or devices may or may not be of the same type or located at the same physical site. Furthermore, content items database 340 may be implemented or executed on the same computing system as ingestion system 300. Additionally, or alternatively, content items database 340 may be implemented or executed on a computing system separate from ingestion system 300. Content items database 340 may be communicatively coupled to ingestion system 300 via a direct connection or via a network. Content items database 340 is used to store content items in accordance with one or more embodiments.

In accordance with one or more embodiments, text database 350 is configured to store textual data in accordance with one or more embodiments. Text database 350 represents any type of storage unit and/or device (e.g., a file system, database, collection of tables, or any other storage mechanism) for storing data. Furthermore, text database 350 may include multiple different storage units and/or devices. The multiple different storage units and/or devices may or may not be of the same type or located at the same physical site. Furthermore, text database 350 may be implemented or executed on the same computing system as ingestion system 300. Additionally, or alternatively, text database 350 may be implemented or executed on a computing system separate from ingestion system 300. Text database 350 may be communicatively coupled to ingestion system 300 via a direct connection or via a network.

In accordance with one or more embodiments, image database 360 is configured to store non-textual image data. In accordance with one or more embodiments, image database 360 represents any type of storage unit and/or device (e.g., a file system, database, collection of tables, or any other storage mechanism) for storing data. Furthermore, image database 360 may include multiple different storage units and/or devices. The multiple different storage units and/or devices may or may not be of the same type or located at the same physical site. Furthermore, image database 360 may be implemented or executed on the same computing system as ingestion system 300. Additionally, or alternatively, image database 360 may be implemented or executed on a computing system separate from ingestion system 300. Image database 360 may be communicatively coupled to ingestion system 300 via a direct connection or via a network.

In accordance with one or more embodiments, picture data 362 is stored in image database 360. In an embodiment, picture data 362 refers to standard image data that may comprise, for example, natural or artificial scenes, objects, or landscapes. This type of data typically includes photographs, artwork, or visual representations of real-world environments. Picture data 362 is composed of pixels that form recognizable patterns, such as edges, textures, and colors that can be processed to identify objects, people, animals, or specific visual elements within the image. Picture data 362 is often used for tasks like scene recognition, object detection, or generating descriptive text based on the visual content present in the image.

In accordance with one or more embodiments, chart and plot data 364 is stored in image database 360. In an embodiment, chart and plot data 364 represents images that comprise visual representations of data, such as bar charts, line graphs, pie charts, or scatter plots. This type of image data is structured to convey quantitative or categorical information visually through axes, data points, and labels. Chart and plot data 364 typically includes various elements, like gridlines, legends, and numerical values, associated with plotted points or bars. The primary focus for processing chart and plot data 364 is extracting the relationships between the data points and generating meaningful interpretations or summaries of the visualized data.

In accordance with one or more embodiments, table image data 366 is stored in image database 360. In an embodiment, table image data 366 includes images that display tabular data, where information is organized into rows and columns. These images often represent tables from scanned documents, PDFs, or images captured from printed materials. Table image data 366 includes structural components, such as cell boundaries, headers, and separators that define the arrangement of data within the table.

In accordance with one or more embodiments, RAG agent 370 is configured to handle complex queries using a retrieval module 372 with a generation module 374. The interaction begins with an input query that is processed by the retrieval module 372. This module is responsible for searching an external or internal document store to identify relevant information that may assist in forming a response. The input query is tokenized and transformed into a vector representation using an embedding model. The embedding is compared to precomputed embeddings in a vector index, using a similarity measure, such as cosine similarity or dot-product similarity, to rank and retrieve the most relevant documents or text passages from the document store.

In accordance with one or more embodiments, retrieval module 372 uses techniques, like dense retrieval or approximate nearest-neighbor search, to quickly narrow down large volumes of data and return a subset of relevant text. Systems, like FAISS or ScaNN, are often used in conjunction with the retrieval module to optimize the speed and accuracy of these searches. The retrieved documents or passages are returned to RAG agent 370 and along with their relevance scores are passed to the generation module 374.

In accordance with one or more embodiments, generation module 374 is responsible for producing a coherent and contextually appropriate response based on both the user query and the retrieved documents from retrieval module 372. The generative model within the module is based on a Transformer architecture, such as GPT or BART. This model takes the concatenated input of the query and the retrieved documents, processes it through multiple layers of self-attention and feed-forward neural networks, and generates the output sequence token-by-token. Tokens are generated by sampling from a probability distribution that the model computes over its vocabulary, conditioned on the tokens generated so far and the entire input sequence.

In accordance with one or more embodiments, generation module 374 leverages the attention mechanisms in the Transformer model to distribute focus between different parts of the input, allowing it to extract relevant details from the retrieved documents and integrate them into the response. The attention heads compute attention scores for the tokens in the sequence, enabling the model to weight certain words and phrases more heavily based on their contextual importance. This mechanism ensures that the generated output incorporates knowledge from the retrieved documents and aligns it with the user's input query.

In accordance with one or more embodiments, retrieval module 372 and generation module 374 work in tandem. Retrieval module 372 provides the necessary contextual information to ensure that the generative model in generation module 374 has access to the most relevant data, while generation module 374 uses this data to inform its generation process and produce an output that reflects both the retrieved information and the generative model's inherent knowledge. RAG agent 370 facilitates the interaction between these two modules, managing the data flow and ensuring the overall process remains efficient and aligned with the input query's requirements.

Additional embodiments and/or examples relating to computer networks are described below in Section 7, titled “Computer Networks and Cloud Networks.”

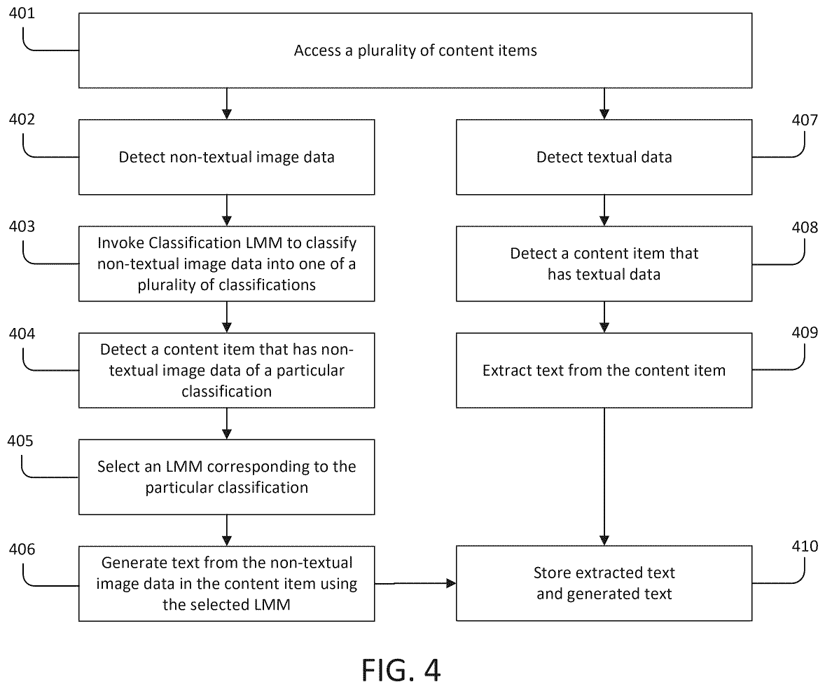

In one or more embodiments, ingestion system 300 refers to hardware and/or software configured to perform operations described herein and may include any or all elements of FIG. 3. Examples of operations for ingestion system 300 are described below with reference to FIG. 4.

In an embodiment, ingestion system 300 and other elements described in connection with FIG. 3 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, an interface refers to hardware and/or software configured to facilitate communications between a user and ingestion system 300 or a RAG system generally. An interface renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of an interface are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, an interface may be specified in one or more other languages, such as Java, C, or C++.

In accordance with one or more embodiment, the ingestion process uses a variety of large multi-modal models. For example an LMM is used to determine image type when an image is detected (e.g., table, chart, document, or picture) in a content item in an embodiment. Each type of detected image may be associated with one or more LMM in an embodiment, where the associated LMMs are configured to extract text from the particular type of image. For example, when a table is detected, an LMM related to table data extraction is used to extract the text from the table, along with table-specific components. Each type of image may be associated with components specific to that type of image. Each of these components may be extracted by an LMM and stored in text that represents the components. As a simple example, the format of a table may be stored in HTML format as text, with the HTML tags indicating the beginning of rows and columns, color, font, font size, and other attributes. The textual data is also stored in the same HTML string. In an embodiment, image-specific components may be stored separately with a corresponding component identifier. A non-exhaustive list of some image components follows.

A table is comprised of several essential components that organize and display data systematically. At its core, a table comprises rows and columns that intersect to form cells where data is entered. The header row is usually the first row, providing the titles or labels for the columns, which helps in identifying the type of data contained within. Columns are vertical divisions of data, each containing specific types of information, such as names, dates, or numerical values. Rows are horizontal divisions, representing a single record or data entry.

Tables also include borders that outline the cells, rows, and columns, providing a visual structure. Cell formatting includes numerous attributes, such as font type, size, color, and background shading, which help to enhance readability and distinguish different sections. Merging cells is a feature that allows combining multiple cells into a single cell, often used for headings or to span data across several columns or rows. Alignment within cells, such as left, right, center, and vertical, ensures that the data is presented neatly.

A table is comprised of several essential components that organize and display data systematically. At its core, a table comprises rows and columns that intersect to form cells where data is entered. The header row is usually the first row, providing the titles or labels for each column, which helps in identifying the type of data contained within. Columns are vertical divisions of data, containing specific types of information, such as names, dates, or numerical values. Rows are horizontal divisions, representing a single record or data entry.

A chart is comprised of various components that work together to represent data visually. The fundamental element of a chart is the data, which includes numerical or categorical information plotted on the chart. Axes are crucial; the X-axis (horizontal) typically represents categories or time intervals, while the Y-axis (vertical) represents numerical values. Gridlines, both horizontal and vertical, help in reading values corresponding to data points more accurately.

Labels play a significant role, providing information about the data, including axis labels, data labels, and chart titles. The legend is a key that explains the symbols, colors, or patterns used in the chart to differentiate between different data series or categories. The plot area is the section within the chart where data points are plotted, covering the space between the axes.

Data series are groups of related data points plotted in the chart, represented by distinct colors or patterns. Markers are symbols used to represent individual data points, such as dots or squares. Trendlines indicate trends or patterns within the data, like linear or exponential trends. Annotations are additional text or graphical elements added to highlight specific data points or trends. The chart title provides the main heading, describing the purpose or content of the chart, while data labels offer specific information about individual data points. Error bars represent variability or uncertainty in the data points.

A document comprises various elements that contribute to its structure, readability, and functionality. The fundamental component of a document is the text that can include paragraphs, headings, subheadings, and lists. Headings and subheadings organize content into sections and subsections, making a document easier to navigate. Paragraphs comprise the main body of text, presenting information in a coherent manner.

Formatting features, such as font type, size, color, and style (bold, italic, underline) enhance the readability and emphasis of specific text sections. Margins and spacing between lines and paragraphs contribute to the document's overall layout and visual appeal. Headers and footers often comprise page numbers, document titles, or author names, providing additional context and navigational aids.

Images and graphics can be embedded to complement the text, providing visual representations of concepts or data. Tables organize and present data systematically within the document. Hyperlinks enable quick navigation to other sections of the document or external resources. Footnotes and endnotes offer additional information or citations without cluttering the main text. Page layout settings, including orientation (portrait or landscape) and column settings, further enhance the document's structure and readability.

A picture is comprised of several components that contribute to its overall composition and visual impact. The primary element of a picture is the image itself, which can be a photograph, illustration, diagram, or any other visual representation. The resolution of the image, measured in pixels per inch (PPI), determines its clarity and detail.

Color is a critical component, encompassing the entire spectrum of hues, saturation, and brightness levels, which together create the visual impression of the picture. Contrast refers to the difference between light and dark areas in the image, enhancing its depth and dimension. Composition involves the arrangement of elements within the picture, guided by different principles, such as the rule of thirds, balance, and symmetry, which contribute to the overall aesthetic and focus of the image.

Borders or frames can be added to pictures to provide a finished look and separate the image from surrounding content. Captions offer descriptive text that provides context or additional information about the picture. Annotations might include arrows, labels, or other markings that highlight specific parts of the image for emphasis or clarification. Metadata includes information embedded in the image file, such as the date it was created, the camera settings used, and copyright details. Filters and effects can be applied to alter the appearance of the image, enhancing certain features or creating artistic styles.

### 5. Content Item Ingestion for Rag Agent

In accordance with one or more embodiments, a multi-modal RAG agent system employs a comprehensive multi-format data ingestion approach to understand and ingest multi-modal information from various document, media, and content formats. A twin-database is used in an embodiment to ensure effective indexing of the information. The system is flexible and able to use both existing and new state-of-the-art indexing algorithms. In an embodiment, an LMM-based generation module is used to generate answers from queries and context with different modalities. In an embodiment, multiple LMM-based models and other machine learning models may be used to ingest a corpus of training data. The multi-modal RAG agent effectively understands multi-modal data by leveraging LMM and computer vision models. It is also able to leverage a variety of indexing, embedding, retrieval, re-ranking technologies, suitable for a scalable and robust product.

In accordance with one or more embodiments, ingestion of content items involves extracting information from source content items and converting that information into a structured format suitable for analysis. This process may include data cleaning, transformation, and indexing. The structured data is then stored in a database, ready for retrieval by the RAG agent. The efficiency of this process is critical for the agent's performance, for it impacts the speed and accuracy of information retrieval.

In accordance with one or more embodiments, interactions with a RAG agent may be conducted through a chat interface or API. Users can initiate sessions by sending queries or prompts, and the agent responds with relevant information or actions based on the user's input. A session maintains continuity, preserving the context of the conversation to provide coherent and meaningful responses throughout the interaction. This capability is particularly useful in applications requiring extended user engagement, such as customer support or educational tutoring.

In an embodiment, a RAG agent supports more than pure text data. One of the major pain points from users of RAG agents is that their knowledge base may comprise PDF documents, MS Word documents, MS PowerPoint slides, etc. These documents with different types can comprise text, image modality, such as graphs, plots, and other visual representations of data, or other important information. Users of a RAG instance can ask questions regarding the information contained in these content items, including the images, graphs, plots, and other information that is not purely textual. An embodiment adds multi-modal support to the RAG Agent service. For example, an embodiment can ingest and leverage PDF documents and images that include graphs, charts, and other visual representations of data and information.

Less sophisticated systems extract captions from images then discard the original images. These approaches are straight-forward. However, an embodiment is more effective because semantic similarity from embedded features are not reliable when comparing images with text. Graph and plots, for example, comprise numeric information that cannot be easily captured by image embedding models. Moreover, for general purpose pictures other than graphs or plots, the image content represented by pixels generally cannot be accurately described by text caption. In accordance with one or more embodiments, image types are differentiated, then the image data is parsed accordingly (e.g., convert plot to table and store as text using a markup language such as HTML to maintain table properties).

FIG. 4 illustrates an example set of operations for ingesting content items for a RAG agent in accordance with one or more embodiments. One or more operations illustrated in FIG. 4 may be modified, rearranged, or omitted. Accordingly, the particular sequence of operations illustrated in FIG. 4 should not be construed as limiting the scope of one or more embodiments.

In an embodiment, the system accesses a plurality of content items (Operation 401). For example, the system may access content items stored in content items database 340. Content items may include documents, plain text, images, image-based documents, video, audio, and other multimedia formats. Documents are typically structured files, like PDFs, Word documents, or spreadsheets, and may include graphs, charts, and tables to visualize or organize data. Plain text refers to unformatted text files such as .txt. Images and image-based documents include visual media, like photos (JPEG, PNG), infographics, or scanned documents. Video files (MP4, MOV, AVI) combine moving images with sound, while audio files (MP3, WAV, AAC) comprise sound.

In accordance with an embodiment, when the system accesses the content items, the system performs indexing and scanning operations to organize content for ingestion by creating references for efficient retrieval. This involves generating an index based on metadata, keywords, and file properties, such as format, size, and timestamps. The system processes content items by reading file formats and identifying elements, such as text, images, audio streams, and embedded media. When encountering structured files, it may extract data from charts, graphs, and tables for indexing. The system supports various file formats and utilizes standard protocols for accessing, reading, and storing data.

In an embodiment, the system detects non-textual image data (Operation 402). At this stage of the ingestion process, the system identifies the types of data associated with each file to be ingested. Type identification may be performed during an initial scan of the content items, or alternatively, as each content item is ingested.

In an embodiment, the system invokes a classification LMM to classify the non-textual image data into one of a plurality of classifications (Operation 403). In an embodiment, the classification process categorizes non-textual image data, such as pictures, charts, documents, graphs, plots, and other image types, in several stages. For example, the input non-textual image data may undergo preprocessing, which may include resizing, normalization, and transformation into a tensor format suitable for the model's input layer. Different types of models may be used. For text-image models, the associated text may be tokenized and embedded alongside the image data. Once preprocessed, a feature extraction mechanism that may be based on a convolutional neural network (CNN), processes the image. Early CNN layers focus on extracting low-level features like edges and textures, while deeper layers capture higher-level abstractions, such as shapes and objects present in the image. In transformer-based models, positional encodings may be added to retain spatial information of the image features.

Once the features are extracted, the model may fuse these image representations with other modalities, such as text, through attention mechanisms. A classification head, generally implemented as a fully connected layer, takes the resulting feature vectors and assigns a probability distribution across predefined classes, like pictures, charts, and graphs. This step typically involves softmax or sigmoid functions to compute the class probabilities. The model's output is a classification label based on the highest probability value.

In an embodiment, the system detects a content item that has non-textual image data of a particular classification (Operation 404). For example, the system may detect a Word document that includes one or more pictures, graphs, and/or charts. In an example embodiment, the system detects a chart within the document.

In an embodiment, the system selects an LMM corresponding to the particular classification (Operation 405). Using the example above, the system selects an LMM that is configured to process charts such as chart and plot LMM 310. The selection process is performed based on an LMM-to-classification mapping accessible to the system. For example, non-textual image data associated with charts and plots may be mapped to chart and plot LMM 310 using a mapping stored in a mapping database. Other types of non-textual image data may be mapped to different LMMs, OCR logic, or table detection and recognition logic.

In an embodiment, the system generates text from the non-textual image data in the content item using the selected LMM (Operation 406). For example, a chart and plot LMM extracts text data from a chart through a series of processes involving image preprocessing, feature extraction, and text recognition. These mechanisms are described in the section related to chart and plot LMM 310. Other LLMs and logic are also described herein. For example, the function of picture LMM 308, ORC logic 314, document LMM 316, table LMM 318, and table detection and recognition logic 320 are described in the section entitled RAG Ingestion Architecture.

In an embodiment, the system detects textual data (Operation 407). For example, while the system identifies the types of data associated with the files to be ingested, type identification may be performed during an initial scan of the content items, or alternatively, as each content item is ingested. This operation and subsequent operations may be performed concurrently with Operation 402 and subsequent operations in an embodiment.

In an embodiment, the system detects a content item that has textual data (Operation 408). Using the previous example, the system may detect a Word document that includes one or more pictures, graphs, and/or charts. In an example embodiment, the system also detects text within the document.

In an embodiment, the system extracts text from the content item (Operation 409). Depending on the type of document, an extraction mechanism is selected. For example, document LMM 316 or OCR logic 314 may be selected. Other logic may be document-type specific. In an embodiment, for example, for Word and PDF documents, the system follows a structured process based on file format parsing and text extraction algorithms. The system identifies the document format, either by file extension or through file signature analysis, and then applies the corresponding parsing technique. For Word documents (e.g., .docx), the system typically decompresses the file, for it is a compressed package containing XML files. The text content is stored in specific XML tags that the system reads and parses to extract the raw text data. The system skips formatting instructions, metadata, and other non-text elements unless specified otherwise in configuration settings for ingestion system 300.

In an embodiment, for PDF documents, the system parses the internal structure that includes a combination of text streams and graphic elements encoded using PDF-specific operators. The system identifies text objects by locating text streams associated with the “Text” operators, such as “Tj” or “TJ,” in the PDF content stream. The system then decodes these streams using the document's character encoding, which may include standard fonts, embedded fonts, or font subsets. The system processes the character codes and maps them to the corresponding Unicode values or text based on the font encoding. Once the text is decoded, the system arranges it according to the page structure, respecting the reading order as specified by the layout.

While extracting text from a document, placeholders may be inserted in the text to indicate the inclusion of non-textual image data (e.g., pictures, charts, etc.) at a particular location within the text. For example, a paragraph A may occur before a particular image in a content item such as a PDF document. Paragraph B may occur after the particular image, so the order of the parsed items would be paragraph A, image, paragraph B. The image may be stored in an image database and associated with an image identifier (e.g., image_142435213). To ensure that the placement context is not lost during the parsing phase, parsing module 304 stores the image identifier as additional text in the text portion of the content item. In this case, the text may be stored as <contents of paragraph A><Image_142435213><contents of paragraph B>.

In an embodiment, the system stores both the extracted text from Operation 409 and the generated text from Operation 406 (Operation 410). In an embodiment, the textual data (including the reference to the image identifier) and the text generated at Operation 406 are stored in text database 350. In accordance with an embodiment, the text generated at Operation 406 is merged with the text extracted at Operation 409. In an embodiment, the process of merging includes placing the generated text at or near the image identifier, resulting in the replacement of the image with text that is generated based on the image. In an embodiment, the textual data is also stored with the corresponding content item identifier. Image identifiers may be used in this way for any type of non-textual image information, including pictures, charts/plots, and tables.

In accordance with one or more embodiments, the system ingests a variety of content items. The system may extract raw text using OCR technology, and/or may leverage a classification LLM to determine the classification for both non-textual image data and textual data. The content items comprise one or more content elements, such as textual data or non-textual image data. Content items may also include metadata that may be associated with content elements. Metadata elements may be associated with a metadata identifier in an embodiment. Metadata identifiers may be placed near the text or may be used to generate tags, like HTML tags, to preserve the purpose of the metadata elements. Alternatively, metadata elements may be stored in a metadata database and associated with an identifier that may be referenced by a RAG agent when generating a response. Some examples of metadata elements are discussed below.

In an embodiment, text may be accompanied by various attributes, such as font types, font sizes, and various metadata, that define its structure and appearance. Fonts determine the visual style of the text, while font sizes establish the scale of different sections, such as body text or headers. Header tags, like H1 through H6, indicate the hierarchical structure of the document, classifying text by its relevance or level within the overall content. Additional metadata, including bold, italic, or underline styles, modifies the presentation of the text by applying specific emphasis. Line spacing, kerning, and letter spacing are other attributes that influence the positioning and distribution of text within the document. The metadata for each text component may include various details, such as the language of the text, hyperlink associations, or indexing markers, that assist in document retrieval or navigation.

In accordance with one or more embodiments, non-textual image data may also be associated with metadata. Metadata for non-textual image data in a document may include information about the image's attributes and properties, both technical and descriptive. This may include the file format (e.g., JPEG, PNG), resolution (measured in DPI or PPI), and dimensions (height and width in pixels). Metadata can also capture color depth, color profile (such as sRGB or CMYK), and compression settings. Additionally, images often comprise descriptive metadata, such as alt text, which provides a textual description of the image, or captions, which add contextual information. Embedded metadata within the image file itself, like EXIF data, can store details about how and when the image was created, including camera settings, date, time, and geolocation coordinates, if applicable.

In accordance with one or more embodiments, the system parses the multi-modal data from various data formats then extracts textual information or a description for each modality, including plain text or text with a bbox, font, font size, etc. When the system extracts a document image, the system applies OCR to extract text with a bbox and estimates the font size from the bbox. The system may also detect tables if any exist, and may linearize tables as text. When extracting charts/plots, the system applies a chart and plot LMM to extract the data illustrated in the chart/plot, extracts the text, and generates a summary and/or description of the chart/plot. For pictures, the system applies a picture LMM to generate a description of the picture. The description may be generated even if the picture does not include text. Additional content types may be ingested using additional components. For example, audio, video, and other media may be ingested using additional components such as LMMs trained to handle the additional data types.

For chart/plots, an embodiment will also extract the captions as below (i.e., bounding boxes). In the context of text capture from images, a “bbox” or “bounding box” is a rectangular border that fully encloses a region of interest, such as text, within an image. The bbox is typically defined by the coordinates of its corners, usually the top-left and bottom-right corners. This bbox is used to identify and isolate specific parts of the image for further processing, such as optical character recognition (OCR) to extract text. The bboxes of the chart/plots are enlarged, and the surrounding text overlapped with the enlarged bboxes will be analyzed to detect the captions. These captions will be combined together with the descriptions for the image and indexed in the text database.

In an embodiment, after the text (with bbox, fonts, font sizes etc.) is obtained, the system will analyze this information and recover the layout of the documents. The layout of the document will be a tree-like structure consisting of sections, subsections, paragraphs, etc. Then, the document will be split to smaller chunks. The chunking module will be aware of the layout information, so it will not break the basic units, such as paragraphs, section headers, tables etc. For example, the chunking module may detect patterns in a document related to font size and use those patterns to determine sections. The chunking module may be configured with a maximum or minimum chunk size and may be configured to allow a minimum or maximum size constraints to be overridden under a variety of use cases, for example, if the chunk is the first or last chunk in a document.

In an embodiment, the extracted and chunked text will be indexed in a text database. Meanwhile, pictures, chart/plots, and table images will be stored in a separate image database with a key or identifier that can connect images with corresponding text in the text database. For example, when text is extracted from an image in a document, such as a PDF, the text from the image may be included as text in the text extracted from the document, and an image identifier may be placed next to the text extracted from the image. This allows the RAG system to detect that the text in a particular portion of a document was extracted from an image, and then the RAG system may access the image from the separate image database. This may be useful, for example, if the RAG system determines that the image should be returned as part of the response to the user's query.

### 6. Multi-Modal Rag Agent Operation

A detailed example is described below for purposes of clarity. Components and/or operations described below should be understood as one specific example that may not be applicable to certain embodiments. Accordingly, components and/or operations described below should not be construed as limiting the scope of any of the claims.

In accordance with one or more embodiments, when a user interacts with the RAG agent, the system operates by integrating a retrieval mechanism and a generation mechanism. The interaction begins with the user input that is parsed and processed by the system to convert it into a format that the underlying models can interpret.

In accordance with one or more embodiments, the process begins with a retrieval phase. The user's input is tokenized, typically using a tokenizer specific to the model architecture (for example, byte-pair encoding in GPT models). This input is then transformed into an embedding-a dense vector representation that captures the semantic meaning of the input text. The embedding is then used to query an external knowledge base or a corpus of documents, typically stored as a set of indexed embeddings created during a pre-processing stage. These embeddings could have been generated using methods like dense passage retrieval (DPR) or other neural retrievers based on models, such as BERT or Sentence-BERT. The query vector is compared against these stored document embeddings using a similarity metric, most commonly cosine similarity or dot-product similarity.

In accordance with one or more embodiments, the similarity search returns a set of documents, references, or text passages that have the closest matching embeddings to the user's query. The retrieved documents may comprise structured or unstructured information, depending on the system's design, and are ranked based on their similarity score.

In accordance with an embodiment, during retrieval, the system first searches the text database for top-k text chunks. A re-rank may be applied to searched results. For those text chunks with descriptors/summaries of picture, chart, plot or table, the system looks up the corresponding images from the image database, obtaining multi-modal references and context.

In accordance with an embodiment, the retrieval module may retrieve text stored in the text database that is relevant to the query sent by the user. The retrieved text may include generated text that was generated from non-textual image data such as a picture. For example, the generated text may say “Picture of George Washington standing on a boat crossing a river.” Alternatively, a reference to the generated text may be included rather than the generated text itself. For example, the generated text may be stored in a separate database, and a reference to that text may be inserted into the retrieved text.

In accordance with one or more embodiments, one or more image identifiers, text identifiers, or other data type identifiers may be included in the text. For example, retrieved text may include textual data that was extracted from a document, generated text that was generated from a picture of George Washington by a picture LMM, and an image identifier that identifies the picture of George Washington that is stored in a picture database. There is no limit to the number or type of references, identifiers, and generated text that may be included in retrieved text. Furthermore, each type of item may include an indicator that indicated that the insertion was not part of the original text. For example, generated text describing a picture may include a tag that indicates the text was generated by a picture LMM such as: <G_PLMM> Picture of George Washington standing on a boat crossing a river.</G_PLMM>. In accordance with one or more embodiments, metadata stored within the retrieved text may be interpreted in a similar way. For example, tags recognized by the retrieval module may indicate certain attributes of the text.

After the retrieval step, the system moves into the generation phase. The original user query, along with the top-ranked retrieved documents, is passed as input to the generative language model. The model is typically based on a transformer architecture, like GPT, BART, or T5, which has been pre-trained on large amounts of text data and fine-tuned for the specific task of integrating retrieved information into its output. The input is tokenized again, forming a sequence of tokens that includes both the original user query and the retrieved context. This combined tokenized input is fed into the transformer layers, where the attention mechanisms allow the model to focus on different parts of the input sequence.

In accordance with one or more embodiments, the generative model processes the input across multiple transformer layers. At each layer, the attention heads compute attention scores that determine how much weight the model should give to each token in the sequence based on its relevance to the current token being processed. The retrieved documents play a crucial role here, as the attention mechanism allows the model to leverage specific details from the retrieved text, generated text, and other indicators, such as if a potentially useful image is associated with the text, to generate a more informed and contextually accurate response. Each transformer layer further refines the hidden representations of the input sequence, culminating in the final layer, where the output is produced as a probability distribution over the model's vocabulary.

In accordance with one or more embodiments, the model samples or selects the most likely sequence of tokens from this probability distribution. This decoding strategy can vary, with different methods, such as greedy decoding, beam search, or nucleus sampling (top-p), being employed depending on the system configuration. The chosen tokens are then converted back into human-readable text through the model's tokenizer, and the response is returned to the user.

In accordance with one or more embodiments, the generation module may retrieve any referenced non-textual image data and use it in generating the response. For example, if a portion of the text used for generating the response includes a reference to an image, chart, plot, or other non-textual image data, the generation module may retrieve the referenced image(s) and include them as part of the response.

In accordance with one or more embodiments, the non-textual image data may be placed throughout the response in context-relevant locations. For example, if a portion of the response discusses a particular country, an image showing a map that includes the location of that country may be placed adjacent to the relevant text. If the response later discusses traditional food or clothing associated with the country, pictures of the food and the clothing will be placed adjacent to the relevant text.

In an embodiment, text that is tagged as generated text is not altered by the generator module, meaning that it is delivered to the user as generated by the LMM that originally generated the text. This helps avoid hallucinations since the generated text is already an interpretation of a non-textual image data item. In an embodiment, text tagged as generated text may be used in the same way as extracted text to generate a response.

In accordance with one or more embodiments, formatting metadata and other metadata may be taken into account by the generation module when generating a response to a user. For example, the use of bold or italic typeface may indicate a particular emphasis on a word or phrase that is relevant.

In accordance with one or more embodiments, a user interface may connect a user to the system. The generation tool employs an LMM to generate one or more answers for the user query given the retrieved multi-modal references/context.

### 7. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

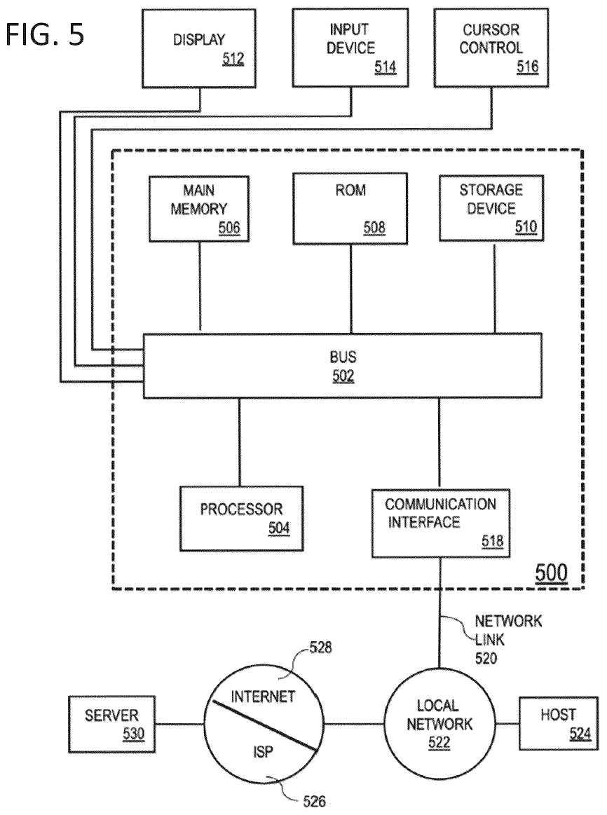

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
accessing a plurality of content items, wherein the plurality of content items comprises:
one or more content items comprising non-textual image data; and
one or more content items comprising textual data;
in response to detecting that the plurality of content items includes non-textual image data, invoking a classification LMM configured to classify non-textual image data into one of a plurality of classifications; and
in response to the classification LMM detecting a first content item of the plurality of content items that comprises non-textual image data corresponding to a first classification of the plurality of classifications, selecting a first LMM from a plurality of LMMs, wherein the first LMM is configured to generate text from non-textual image data corresponding to the first classification.

2. The non-transitory media of claim 1, wherein the non-textual image data includes one or more of:
a table;
a chart;
a document; or
a picture.

3. The non-transitory media of claim 1, wherein:
the first content item comprises a table;
the first classification is associated with tables;
the first LMM is a table LMM;
the operations further comprise:
using the first LMM to generate table textual data from the first content item; and
using the table LMM to store table component data comprising information about table-specific components from the first content item.

4. The non-transitory media of claim 2, wherein the operations further comprise:
in response to the classification LMM detecting a second content item of the plurality of content items that comprises non-textual image data corresponding to a chart:
selecting a chart LMM from the plurality of LMMs, wherein the chart LMM is configured to generate text from non-textual image data corresponding to charts; and
using the chart LMM to generate chart textual data from the second content item.

5. The non-transitory media of claim 2, wherein the operations further comprise:
in response to the classification LMM detecting a third content item of the plurality of content items that comprises non-textual image data corresponding to a document:
selecting a document LMM from the plurality of LMMs, wherein the document LMM is configured to generate text from non-textual image data corresponding to documents; and
using the document LMM to generate document textual data from the third content item.

6. The non-transitory media of claim 2, wherein the operations further comprise:
in response to the classification LMM detecting a fourth content item of the plurality of content items that comprises non-textual image data corresponding to a picture:
selecting a picture LMM from the plurality of LMMs, wherein the picture LMM is configured to generate text from non-textual image data corresponding to pictures; and
using the picture LMM to generate image textual data from the fourth content item.

7. The non-transitory media of claim 2, wherein the first content item comprises both textual data and non-textual data, wherein the instructions further comprise:
extracting first textual data and second textual data from the first content item, wherein the first textual data occurs in the first content item before the table and the second textual data occurs after the table;
generating a table identifier corresponding to the table; and
storing a copy of the table using the table identifier as an index value.

8. The non-transitory media of claim 7, wherein the instructions further comprise:
generating a first text string, wherein the first text string comprises the first textual data, the table textual data, the table identifier, and the second textual data.

9. The non-transitory media of claim 8, wherein the first textual data is before the table textual data and the table identifier in the first text string, and the second textual data is after the table textual data and the table identifier in the first text string.

10. The non-transitory media of claim 9, wherein the instructions further comprise:
chunking the first text string into corresponding chunks based at least in part on the anticipated size of the corresponding chunks; and
storing the chunks corresponding to the first text string in a text database.

11. The non-transitory media of claim 10, wherein the instructions further comprise:
in response to a first query to a RAG agent comprising a RAG LMM, generating a first response based at least in part on the first text string, wherein the first response comprises the table and at least a portion of the table textual data, wherein generating the first response comprises fetching the table using the table identifier.

12. The non-transitory media of claim 1, wherein:
the first content item comprises both textual data and non-textual data;
the first content item comprises a chart;
the first classification is associated with charts;
the first LMM is a chart LMM;
the operations further comprise:
using the first LMM to generate chart textual data from the first content item;
using the chart LMM to store table component data comprising information about chart-specific components from the first content item;
wherein the instructions further comprise:
extracting first textual data and second textual data from the first content item, wherein the first textual data occurs before the chart and the second textual data occurs after the chart;
generating a chart identifier corresponding to the chart;
storing a copy of the chart using the chart identifier as an index value; and
generating a first text string, wherein the second text string comprises the first textual data, the chart textual data, the chart identifier, and the second textual data, wherein the first textual data is before the chart textual data and the chart identifier in the first text string, and the second textual data is after the chart textual data and the chart identifier in the first text string.

13. The non-transitory media of claim 12, wherein the instructions further comprise:
chunking the first text string into corresponding chunks based at least in part on the anticipated size of the corresponding chunks; and
storing the chunks corresponding to the first text string in a text database.

14. The non-transitory media of claim 13, wherein the instructions further comprise:
in response to a first query to a RAG agent comprising a RAG LMM, generating a first response based at least in part on the first text string, wherein the first response comprises the chart and at least a portion of the chart textual data, wherein generating the first response comprises fetching the chart using the chart identifier.

15. The non-transitory media of claim 1, wherein:
the first content item comprises both textual data and non-textual data;
the first content item comprises a document;
the first classification is associated with documents;
the first LMM is a document LMM;
the operations further comprise:
using the first LMM to generate document textual data from the first content item;
using the document LMM to store table component data comprising information about document-specific components from the first content item;
wherein the instructions further comprise:
extracting first textual data and second textual data from the first content item, wherein the first textual data occurs before the document and the second textual data occurs after the document;
generating a document identifier corresponding to the document;
storing a copy of the document using the document identifier as an index value; and
generating a first text string, wherein the second text string comprises the first textual data, the document textual data, the document identifier, and the second textual data, wherein the first textual data is before the document textual data and the document identifier in the first text string, and the second textual data is after the document textual data and the document identifier in the first text string.

16. The non-transitory media of claim 13, wherein the instructions further comprise:
in response to a first query to a RAG agent comprising a RAG LMM, generating a first response based at least in part on the first text string, wherein the first response comprises the document and at least a portion of the document textual data, wherein generating the first response comprises fetching the document using the document identifier.

17. The non-transitory media of claim 1, wherein:
the first content item comprises both textual data and non-textual data;
the first content item comprises a picture;
the first classification is associated with pictures;
the first LMM is a picture LMM;
the operations further comprise:
using the first LMM to generate picture textual data from the first content item;
using the picture LMM to store table component data comprising information about picture-specific components from the first content item;
wherein the instructions further comprise:
extracting first textual data and second textual data from the first content item, wherein the first textual data occurs before the picture and the second textual data occurs after the picture;
generating a picture identifier corresponding to the picture;
storing a copy of the picture using the picture identifier as an index value; and
generating a first text string, wherein the second text string comprises the first textual data, the picture textual data, the picture identifier, and the second textual data, wherein the first textual data is before the picture textual data and the picture identifier in the first text string, and the second textual data is after the picture textual data and the picture identifier in the first text string.

18. The non-transitory media of claim 13, wherein the instructions further comprise:
in response to a first query to a RAG agent comprising a RAG LMM, generating a first response based at least in part on the first text string, wherein the first response comprises the picture and at least a portion of the picture textual data, wherein generating the first response comprises fetching the picture using the picture identifier.

19. A method comprising:
accessing a plurality of content items, wherein the plurality of content items comprises:
one or more content items comprising non-textual image data; and
one or more content items comprising textual data;
in response to detecting that the plurality of content items includes non-textual image data, invoking a classification LMM configured to classify non-textual image data into one of a plurality of classifications; and
in response to the classification LMM detecting a first content item of the plurality of content items that comprises non-textual image data corresponding to a first classification of the plurality of classifications, selecting a first LMM from a plurality of LMMs, wherein the first LMM is configured to generate text from non-textual image data corresponding to the first classification;
wherein the method is performed by at least one device including a hardware processor.

20. A system comprising:
at least one device including a hardware processor;
the system being configured to perform operations comprising:
accessing a plurality of content items, wherein the plurality of content items comprises:
one or more content items comprising non-textual image data; and
one or more content items comprising textual data;
in response to detecting that the plurality of content items includes non-textual image data, invoking a classification LMM configured to classify non-textual image data into one of a plurality of classifications; and
in response to the classification LMM detecting a first content item of the plurality of content items that comprises non-textual image data corresponding to a first classification of the plurality of classifications, selecting a first LMM from a plurality of LMMs, wherein the first LMM is configured to generate text from non-textual image data corresponding to the first classification.
